(19) United States
(12) Patent Application Publication
(10) Pub. No.: US 2021/0254857 A1
(43) Pub. Date: Aug. 19, 2021

(54) A CONNECTION DEVICE AND A FRAME PROVIDED WITH SUCH A DEVICE

(71) Applicant: MUNTERS EUROPE AKTIEBOLAG, Kista (SE)

(72) Inventor: Ola Sylvan, Trangsund (SE)

(21) Appl. No.: 17/252,141

(22) PCT Filed: May 27, 2019
(86) PCT No.: PCT/SE2019/050488

§ 371 Date: Dec. 14, 2020

(30) Foreign Application Priority Data
Jun. 18, 2018 (SE) 1850738-4

(51) Int. Cl. F24F 13/20; F16B 17/00

(52) U.S. Cl. CPC F24F 13/20; F16B 7/0446; F16B 17/00

(57) ABSTRACT

A connection device for a frame, the connection device comprising a body comprising: a first engagement member (1) and a second engagement member (2). Said body comprises a sealing flange (13) which is configured to extend in parallel alignment with a first flange (7) of a first beam (4) and with a second flange of a second beam when the first and second beams are connected to the connection device via the first and second engagement members (1, 2) respectively, and which sealing flange (13) comprises a first recess (14) configured for receiving the first flange (7) of the of first beam (4) when the first beam (4) is connected to the connection device via the first engagement member (1), and a second recess (15) configured for receiving the second flange of the second beam when the second beam is connected to the connection device via the second engagement member (2).

### TECHNICAL FIELD

The present invention relates to a connection device for a frame, the connection device comprising a body comprising:
a first engagement member configured to engage an end portion of a first beam extending in a first direction when the first beam is connected to the connection device via the first engagement member, and
a second engagement member configured to engage an end portion of a second beam extending in a second direction generally perpendicular to said first direction when the second beam is connected to the connection device via the second engagement member,
wherein the first beam comprises a first flange and the second beam comprises a second flange and wherein said first and second flanges are configured to extend in parallel alignment with each other on a first side of the first and second flanges when the first beam is connected to the second beam via the first and second engagement members of the connection device.

The present invention also relates to a frame comprising a first beam, a second beam and a connection device according to the invention, wherein said first and second beams are interconnected by means of said connection device.

### BACKGROUND

Box arrangements in which a plurality of beams are interconnected such that they form a box framework are well known in prior art. Some of the beams are connected end to end in corner regions of the box and some of the beams are connected with their end to a longitudinal side of another beam, such that one or more openings aimed for the housing of a window or a wall element is formed in the box framework.

The beams may consist of hollow beam profiles provided with flanges that form support surfaces for the windows or wall elements or form sealing surfaces against which the windows or wall elements may bear in a sealing way. A reliable sealing connection between beams and between windows and beams or between wall elements and beams is of particular interest in box arrangements in which a predetermined pressure difference compared to outside of the box arrangement is to be provided. This is, for instance, the case in box arrangements in which a de-humidifier is arranged inside the box arrangement and a certain differential pressure is to be generated and maintained inside the box arrangement.

Different designs of connection devices have been suggested by prior art for the purpose of connecting the ends of beams to each other in a corner of a box arrangement such that flanges of the beams form a surface against which windows and wall elements may bear in sealing way. Connection devices comprising engagement members to which the ends of the respective beam are connected are disclosed by prior art. According to such designs, the flange of a first beam is arranged to bear tightly on the flange of another beam, such that there is sealing also between the flanges of interconnected beams. However, due to production tolerances of the beams and flanges, and the fact that such beams and flanges are often made of metals that are not easily deformed in order to provide sealing engagement with each other, there may be leakage between the flanges of interconnected beams.

It is an object of the present invention to present a connection device for a box arrangement or a frame, which connection device provides for efficient and reliable connection of beams in a corner of the box arrangement or frame, and which provides for efficient and reliable connection of an end of a beam to the end of another beam and that provides for good sealing between the flanges of such beams.

### SUMMARY OF THE INVENTION

The object of the invention is achieved by means of the initially defined connection device, which is characterised in that said body comprises a sealing flange which is configured to extend in parallel alignment with the first flange of the first beam and with the second flange of the second beam on said first side of the first flange and the second flange when the first and second beams are connected to the connection device via the first and second engagement members respectively, and which sealing flange comprises a first recess configured for receiving the first flange of the of first beam when the first beam is connected to the connection device via the first engagement member, and a second recess configured for receiving the second flange of the second beam when the second beam is connected to the connection device via the second engagement member. The sealing flange forms a sealing body provided between the first and second flange and physically separates the first and second flange from each other. According to one embodiment, the first recess forms a pocket into which the first flange is inserted as the first beam is connected to the first engagement member by a rectilinear motion in the direction of its longitudinal axis. According to one embodiment, the second recess forms a pocket into which the second flange is inserted as the second beam is connected to the second engagement member by a rectilinear motion in the direction of its longitudinal axis. Parallel alignment may be referred to as planar alignment in the sense that the elements being in parallel alignment have outer surfaces that extend in the same plane.

According to one embodiment, the sealing flange has a surface that is in planar alignment with the first and second flanges on said first side of the first and second flanges when the first and second beams are connected to the connection device via the first and second engagement member respectively. Together with the surfaces of the first and second flanges on said first side, said surface of the sealing flange forms a continuous surface against which the frame of a window, a wall element or a door may be applied in a sealing way. Preferably, a further sealing element is provided between said continuous surface formed by the first and second flanges and the surface of the sealing flange and a window, wall element or door for further sealing functionality.

According to one embodiment, the first recess has a depth corresponding to the thickness of the first flange, and the second recess has a depth corresponding to the thickness of the second flange. Thereby, sealing functionality is further improved.

According to one embodiment, the connection device is characterised in that it comprises a third engagement member configured to engage an end portion of a third beam extending in a third direction generally perpendicular to said first direction and to said second direction when the third beam is in connected to the connection device via the third engagement member, and that the third beam comprises a third flange and the second beam comprises a fourth flange, and the third and fourth flanges are configured to extend in parallel alignment with each other on a first side of the third and fourth flanges when the third beam is connected to the second beam via the third and second engagement members of the connection device, and that said body comprises a second sealing flange which is configured to extend in parallel alignment with the third flange of the third beam and with the fourth flange of the second beam on said first side of the third flange and the fourth flange when the third and second beams are connected to the connection device via the third and second engagement member respectively, and which second sealing flange comprises a third recess configured for receiving the third flange of the of third beam when the third beam is connected to the connection device via the third engagement member, and a fourth recess configured for receiving the fourth flange of the second beam when the second beam is connected to the connection device via the second engagement member.

According to one embodiment, the second sealing flange has a surface that is in planar alignment with the third and fourth flanges on said first side of the third and fourth flanges when the third and second beams are connected to the connection device via the third and second engagement member respectively.

According to one embodiment, the third recess has a depth corresponding to the thickness of the third flange, and the fourth recess has a thickness corresponding to the thickness of the fourth flange.

The object of the invention is also achieved by means of a frame comprising a first beam, a second beam and a connection device as described hereinabove or hereinafter, said frame being characterised in that the first and second are connected to each other via the connection device, wherein the first beam is in engagement with the first engagement member and the second beam is in engagement with the second engagement member. The first and second flanges are received by the first and second recesses and physically separated by a portion of the first sealing flange. According to one embodiment, the sealing flange or flanges of the connection device that are provided with recesses for the reception of beam flanges are constituted by a polymer, while the beam flanges that are housed in said recesses are constituted by a metal alloy, typically an aluminium alloy.

According to one embodiment, said first side of the first flange and of the second flange extends in a plane parallel with the longitudinal axis of the first beam and with the longitudinal axis of the second beam.

According to one embodiment, the frame is part of a box arrangement that comprises a wall element, a window or a door which extends in plane parallel with the longitudinal axis of the first beam and to the longitudinal axis of the second beam and which bears on a surface formed by said first flange, second flange and first sealing flange on said first side of the first flange and the second flange. The present invention may refer to such a box arrangement.

According to one embodiment, the connection device comprises a third engagement member configured to engage an end portion of a third beam extending in a third direction generally perpendicular to said first direction and to said second direction when the third beam is in connected to the connection device via the third engagement member, and the frame comprises a third beam, which is connected to the third engagement member.

According to one embodiment, said first side of the third flange and of the fourth flange extends in a plane, which is parallel with the longitudinal axis of the third beam and to the longitudinal axis of the second beam.

According to one embodiment, the frame forms part of a box arrangement that comprises a wall element, a window or a door which extends in plane parallel with the longitudinal axis of the third beam and to the longitudinal axis of the second beam and which bears on a surface formed by said third flange, fourth flange and second sealing flange on said first side of the third flange and the fourth flange. The present invention may refer to such a box arrangement.

According to one embodiment, the frame is characterised in that the first beam has an opening in the end thereof connected to the connection device, and that the first engagement member projects into said opening of the first beam, and that the second beam has an opening in the end thereof connected to the connection device, and that the second engagement member projects into said opening of the second beam.

According to one embodiment of the invention, the third beam has an opening in the end thereof connected to the connection device, and the third engagement member projects into said opening of the third beam.

Further features and advantages of the present invention will be presented in the following detailed description of embodiments.

### BRIEF DESCRIPTION OF THE DRAWINGS

Embodiments of the present invention will be presented more in detail and by way of example in the following detailed description with reference to the annexed drawing, on which:

FIG. 1 is a perspective view of a connection device according to the invention,

FIG. 2 is a side view of the connection device shown in FIG. 1 as seen from a first angle,

FIG. 3 shows the connection device shown in FIGS. 1 and 2 from a second angle,

FIG. 4 shows the connection device shown in FIG. 1 as seen from below,

FIG. 5 is a view from above of the connection device shown in FIG. 1,

FIG. 6 is a perspective view showing the attachment of a first beam to the connection device shown in FIGS. 1-5,

FIG. 7 is a perspective view showing the attachment of a further beam to the connection device shown in FIGS. 1-5,

FIG. 8 is a perspective view of a part of frame of the invention in which a first beam, a second beam and a third beam are interconnected by a connection device according to the invention,

FIG. 9 is a further perspective view showing the part of the frame shown in FIG. 8,

FIG. 10 is a side view of the part shown in FIGS. 8 and 9,

FIG. 11 is a cross section according to B-B in FIG. 10, and

FIG. 12 is a perspective view of a box arrangement provided with a frame according to the invention.

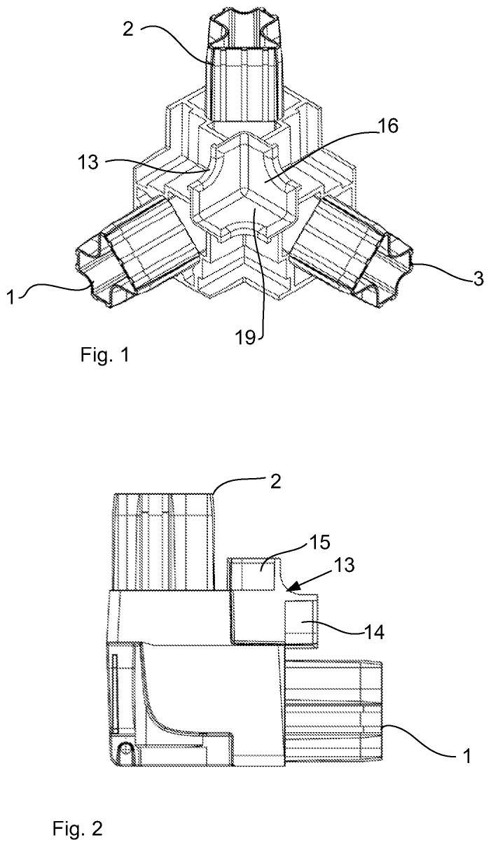

### DETAILED DESCRIPTION

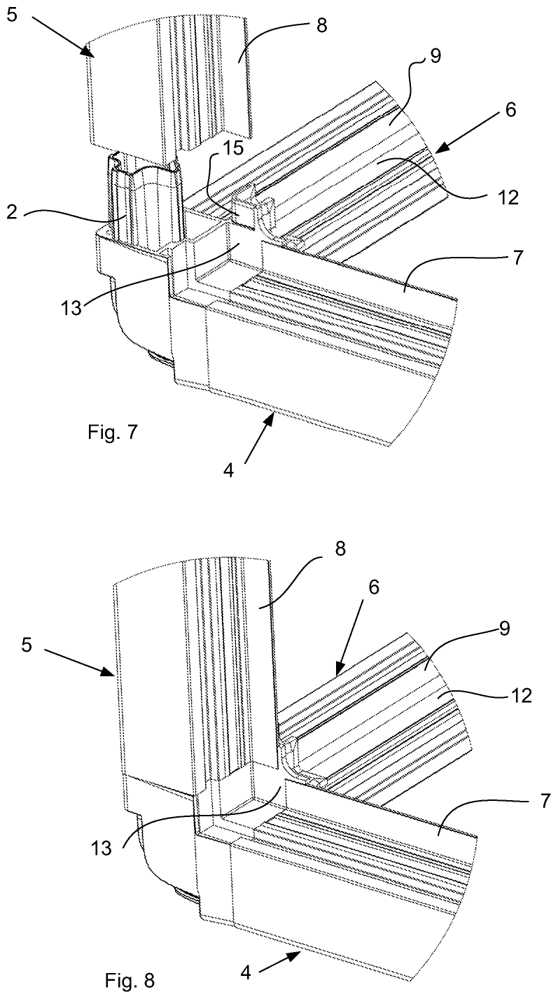

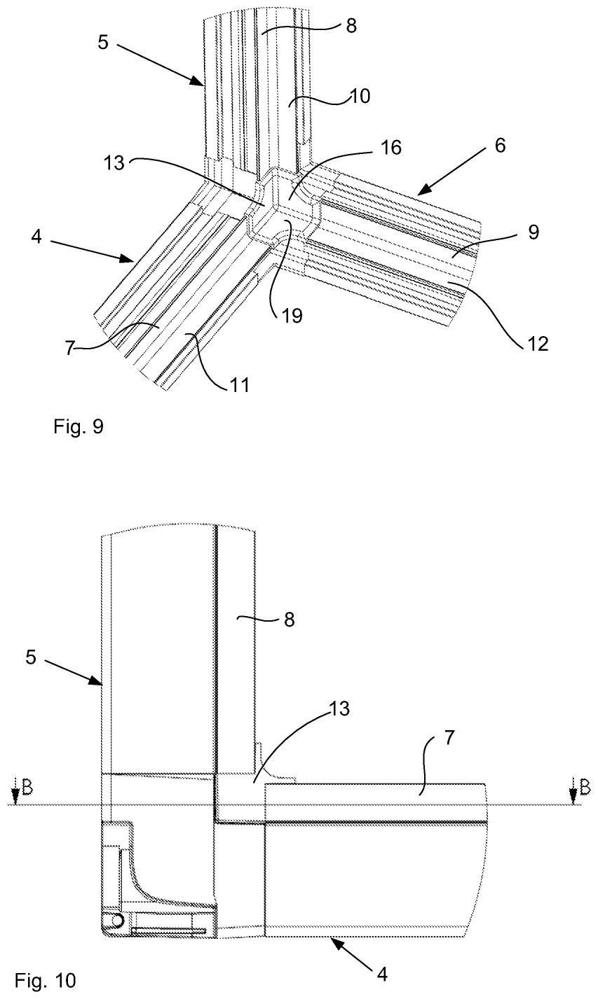

FIG. 1 shows a connection device according to one embodiment of the present invention. Reference is also made to FIGS. 6-12 that show a frame according to the invention comprising the connection device. The connection device comprises a body that comprises a first engage member 1, a second engagement member 2 and a third engagement 3. The first, second and third engagement members 1, 2, 3 are formed by a respective projection configured to be inserted into an opening in an end of a first beam 4, a second beam 5 and a third beam 6 respectively and thereby engage the respective beam 4, 5, 6 and interconnect said beams 4-6 to form a corner of a frame.

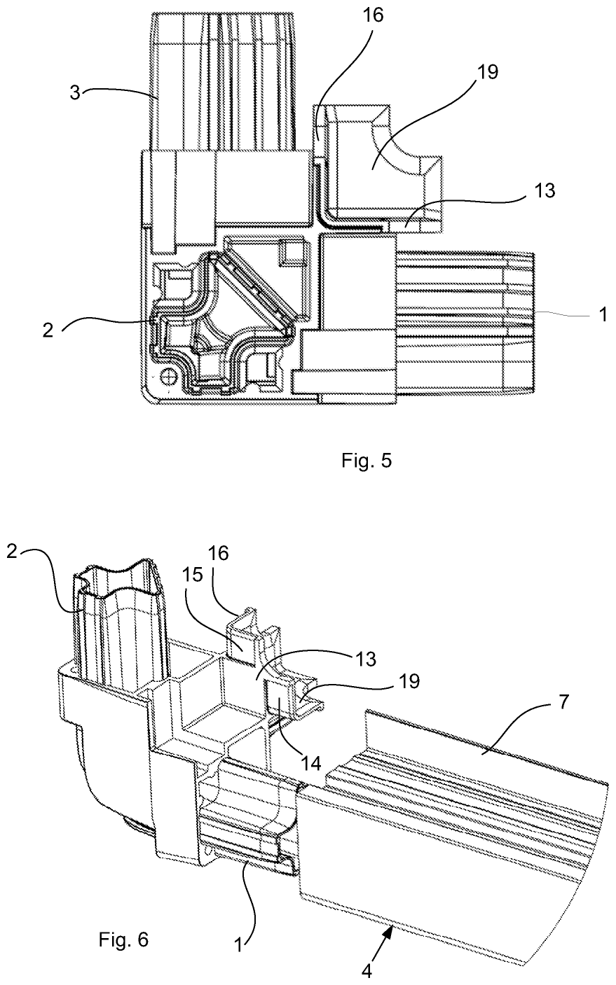

FIGS. 4 and 5 show how the beams 4-6 are attached to the respective engagement member 1-3. The respective beam 4-6 is moved rectilinearly in a direction corresponding to its longitudinal direction such that it engages with its respective engagement member 1-3. The movement is a relative motion. Accordingly, the moving part may as well be the connection device.

With reference to FIGS. 8-12 an embodiment of the frame according to the invention is shown in which a first beam 4, a second beam 5 and a third beam are interconnected by means of a connection device according to the invention. The first engagement 1 member engages an end portion of a first beam 4, wherein the first beam 4 extends in a first direction when the first beam 4 is connected to the connection device via the first engagement member 1. The second engagement member 2 engages an end portion of the second beam 5, wherein the second beam 5 extends in a second direction generally perpendicular to said first direction. The third engagement member 3 engages an end portion of the third beam 6, wherein the third beam 6 extends in a third direction generally perpendicular to said first direction and to said second direction.

The first beam 4 comprises a first flange 7 and the second beam 5 comprises a second flange 8 wherein said first and second flanges 7, 8 extend in parallel alignment with each other on a first side of the first and second flanges 7, 8 when the first beam 4 is connected to the second beam 5 via the first and second engagement members 1, 2 of the connection device. The first and second flanges 7, 8 are generally flat and extend in a plane that is parallel with the first and second directions and to which the third direction is a normal. In the embodiment shown, said first side is a side turned towards the exterior of a box defined by the beams 4, 5, 6, but it could, alternatively, be a side turned towards the interior of said box. The first and second flanges 7, 8 form support surfaces for a window, a wall element or a door that may be positioned in an opening in a box partly defined by the first and second beams 1.

In a corresponding way, the third beam 6 comprises a third flange 9, and the second beam 5 comprises a fourth flange 10, perpendicular to the second flange 8. The third and fourth flanges 9, 10 extend in parallel alignment with each other on a first side of the third and fourth flanges 9, 10. The fourth and fifth flanges 9, 10 form support surfaces for a window, a wall element or a door that may be positioned in an opening in a box partly defined by the second and third beams 5, 6. The third and fourth flanges 9, 10 are generally flat and extend in a plane that is parallel with the third and second directions and to which the first direction is a normal.

In a corresponding way, the first beam 4 comprises an fifth flange 11, perpendicular to the first flange 7, and the third beam 6 comprises a sixth flange 12, perpendicular to the third flange 9. The fifth and sixth flanges 11, 12 extend in parallel alignment with each other on a first side of the fifth and sixth flanges 11, 12. The fifth and sixth flanges 11, 12 form support surfaces for a window, a wall element or a door that may be positioned in an opening in a box partly defined by the first and third beams 4, 6. The fifth and sixth flanges 11, 12 are generally flat and extend in a plane that is parallel with the first and third directions and to which the second direction is a normal.

The connection device is characterised in that said body comprises a sealing flange 13, which extends in parallel alignment with the first flange 7 of the first beam 4 and with the second flange 8 of the second beam 5 on said first side of the first flange 4 and the second flange 5. Said sealing flange 13 comprises a first recess 14 that receives the first flange 7, and a second recess 15 that receives the second flange 8. The respective recess 14, 15 has a depth that corresponds to the thickness of the flange 7, 8 that it is housing. Together with the first and second flanges 7, 8, the sealing flange 13 forms a continuous support surface for a window, a wall element or a door on said first side of the first and second flanges 7, 8.

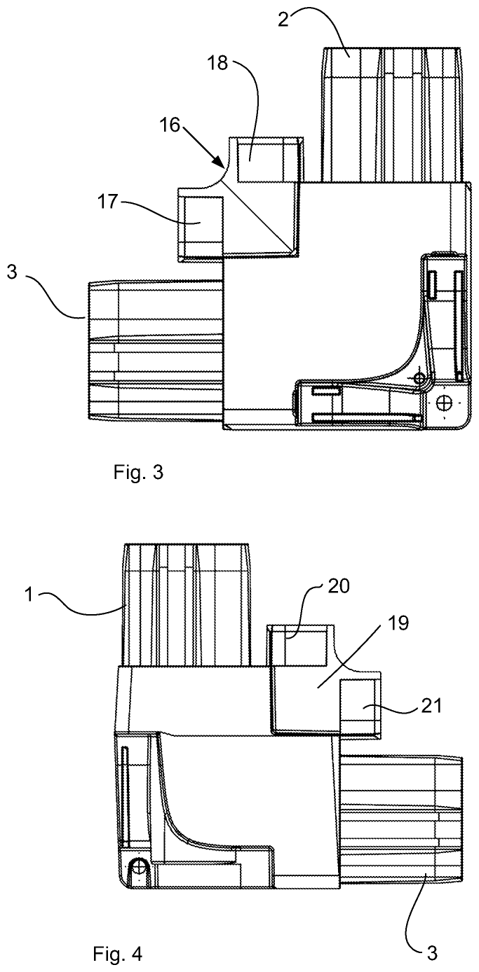

The connection device also comprises a second sealing flange 16, which extends in parallel alignment with the third flange 9 of the third beam 6 and with the fourth flange 10 of the second beam 5 on said first side of the third flange 9 and the fourth flange 10. The second sealing flange 16 comprises a third recess 17 that receives the third flange 9 of the third beam 6, and a fourth recess 18 that receives the fourth flange 10 of the second beam 6 (see FIG. 3). The respective recess 17, 18 has a depth that corresponds to the thickness of the flange 9, 10 that it is housing. Together with the third and fourth flanges 9, 10, the second sealing flange 16 forms a continuous support surface for a window, a wall element or a door on said first side of the third and fourth flanges 9, 10.

The connection device also comprises a third sealing flange 19, which extends in parallel alignment with the fifth flange 11 of the first beam 4 and with the sixth flange 12 of the third beam 6 on said first side of the fifth flange 11 and the sixth flange 12. The third sealing flange 19 comprises a fifth recess 20 that receives the fifth flange 11 and a sixth recess 21 that receives the sixth flange 12. The respective recess 20, 21 has a depth that corresponds to the thickness of the flange 11, 12 that it is housing. Together with the fifth and sixth flanges 11, 12, the third sealing flange 19 forms a continuous support surface for a window, a wall element or a door on said first side of the fifth and sixth flanges 11, 12.

The first, second and third sealing flanges 13, 16, 19 extend in planes that are perpendicular to each other. They are sealingly interconnected along lines extending in said first, second and third directions and form a corner.

The connection device is symmetric in the sense that the first, second and third engagement members 1, 2, 3 have the same shape and size and that the first, second and third sealing flanges 13, 16, 19 have the same shape and size. The engagement members 1, 2, 3 have a non-circular cross-section and engages with the beams 4, 5, 6 in such a way that the beams are prevented from rotating around their respective longitudinal axis when being in engagement with their respective engagement member. The first, second, third, fourth, fifth and sixth flanges 7-12 are provided on a side of the respective first, second and third beam 4, 5, 6 that is directed towards the interior of a box partly defined by said beams. The first, second, third, fourth, fifth and sixth recesses 14, 15, 17, 18, 20, 21 are provided on a side of the respective first, second and third sealing flange 13, 16, 19 that is directed towards the exterior of a box partly defined by said beams 4-6. The above-mentioned first side of the first, second, third, fourth, fifth and sixth flange is a side directed towards the exterior of a box partly defined by said beams 4-6.

The connection device is made of a polymer while the beams 4-6 and the flanges 7-12 are made of an aluminium alloy.

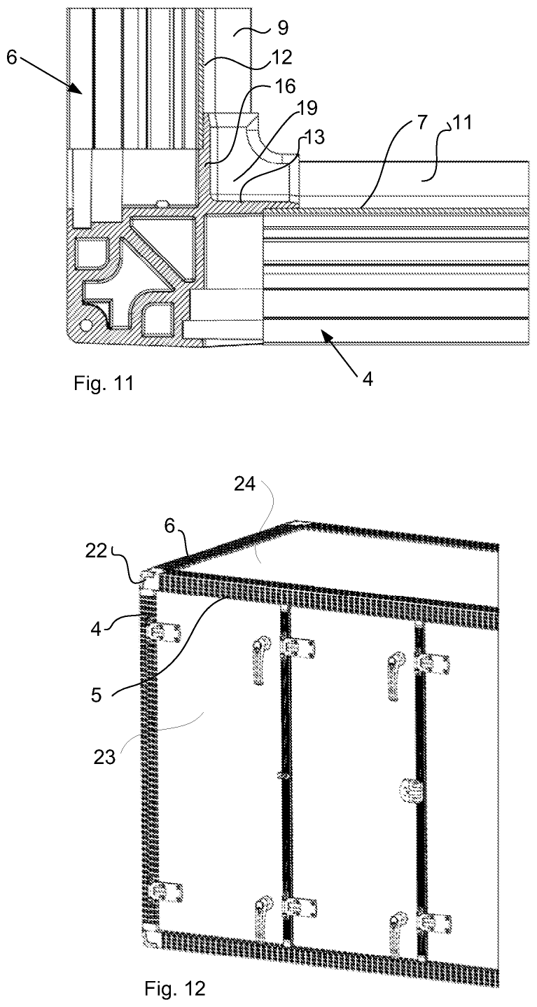

FIG. 12 shows an example of a box arrangement comprising a frame according to the present invention, in which a first beam 4, a second beam 5 and a third beam 6 are interconnected in a corner region of the box arrangement by means of a connection device 22 as described hereinabove. Surfaces formed by the combinations of beam flanges and sealing flanges described hereinabove act as support surfaces for a door 23 and a wall element 24 shown in FIG. 11.

1. A connection device for a frame, the connection device comprising a body comprising:
a first engagement member configured to engage an end portion of a first beam extending in a first direction when the first beam is connected to the connection device via the first engagement member; and
a second engagement member configured to engage an end portion of a second beam extending in a second direction generally perpendicular to the first direction when the second beam is connected to the connection device via the second engagement member,
wherein the first beam comprises a first flange and the second beam comprises a second flange and wherein the first and second flanges are configured to extend in parallel alignment with each other on a first side of the first and second flanges when the first beam is connected to the second beam via the first and second engagement members of the connection device, and
wherein the body comprises a sealing flange which is configured to extend in parallel alignment with the first flange of the first beam and with the second flange of the second beam on the first side of the first flange and the second flange when the first and second beams are connected to the connection device via the first and second engagement members respectively, and the sealing flange comprises a first recess configured for receiving the first flange of the first beam when the first beam is connected to the connection device via the first engagement member, and a second recess configured for receiving the second flange of the second beam when the second beam is connected to the connection device via the second engagement member.

2. A connection device according to claim 1, wherein the sealing flange has a surface that is in planar alignment with the first and second flanges on the first side of the first and second flanges when the first and second beams are connected to the connection device via the first and second engagement member, respectively.

3. A connection device according to claim 1, wherein the first recess has a depth corresponding to the thickness of the first flange, and the second recess has a depth corresponding to the thickness of the second flange.

4. A connection device according to claim 1, further comprising:
a third engagement member configured to engage an end portion of a third beam extending in a third direction generally perpendicular to the first direction and to the second direction when the third beam is connected to the connection device via the third engagement member, and that the third beam comprises a third flange and the second beam comprises a fourth flange, and the third and fourth flanges are configured to extend in parallel alignment with each other on a first side of the third and fourth flanges when the third beam is connected to the second beam via the third and second engagement members of the connection device, and that the body comprises a second sealing flange which is configured to extend in parallel alignment with the third flange (9) of the third beam and with the fourth flange of the second beam on the first side of the third flange and the fourth flange when the third and second beams are connected to the connection device via the third and second engagement members, respectively, and which second sealing flange comprises a third recess configured for receiving the third flange of the third beam when the third beam is connected to the connection device via the third engagement member, and a fourth recess configured for receiving the fourth flange of the second beam when the second beam is connected to the connection device via the second engagement member.

5. A connection device according to claim 4, wherein the second sealing flange has a surface that is in planar alignment with the third and fourth flanges on the first side of the third and fourth flanges when the third and second beams are connected to the connection device via the third and second engagement members, respectively.

6. A connection device according to claim 4, wherein the third recess has a depth corresponding to the thickness of the third flange, and the fourth recess has a thickness corresponding to the thickness of the fourth flange.

7. A frame, comprising a first beam, a second beam and a connection device according to claim 1, wherein the first and second beams are connected to each other via the connection device, the first beam is in engagement with the first engagement member and the second beam is in engagement with the second engagement member.

8. A frame according to claim 7, wherein the first side of the first flange and of the second flange extends in a plane parallel with the longitudinal axis of the first beam and to the longitudinal axis of the second beam.

9. A frame according to claim 8, wherein the frame forms part of a box arrangement that comprises a wall element, a window or a door which extends in plane parallel with the longitudinal axis of the first beam and to the longitudinal axis of the second beam and which bears on a surface formed by the first flange, the second flange and the first sealing flange on the first side of the first flange and the second flange.

10. A frame according to claim 8, wherein the connection device comprises a third engagement member configured to engage an end portion of a third beam extending in a third direction generally perpendicular to the first direction and to the second direction when the third beam is connected to the connection device via the third engagement member, and that the frame comprises a third beam, which is connected to the third engagement member.

11. A frame according to claim 10, wherein the first side of the third flange and of the fourth flange extends in a plane parallel with the longitudinal axis of the third beam and to the longitudinal axis of the second beam.

12. A frame according to claim 11, wherein the frame forms part of a box arrangement that comprises a wall element, a window or a door which extends in plane parallel with the longitudinal axis of the third beam and to the longitudinal axis of the second beam and which bears on a surface formed by the third flange, the fourth flange and the second sealing flange on the first side of the third flange and the fourth flange.

13. A frame according to claim 7, wherein the first beam has an opening in the end thereof connected to the connection device, the first engagement member projects into the opening of the first beam, the second beam has an opening in the end thereof connected to the connection device, and that the second engagement member projects into the opening of the second beam.

14. A frame according to claim 11, wherein the third beam has an opening in the end thereof connected to the connection device, and the third engagement member projects into the opening of the third beam.
